(19) United States
(12) Patent Application Publication
(10) Pub. No.: US 2011/0242033 A1
(43) Pub. Date: Oct. 6, 2011

(54) APPARATUS AND METHOD FOR DETERMINING USER INPUT PATTERN IN A PORTABLE TERMINAL

(75) Inventors: Hyoung-Il Kim, Seongnam-si (KR); Jin-Woo Yang, Seoul (KR); Hyun-Woo Lim, Seoul (KR)

(73) Assignee: SAMSUNG ELECTRONICS CO., LTD., Suwon-si (KR)

(21) Appl. No.: 13/077,774

(22) Filed: Mar. 31, 2011

(30) Foreign Application Priority Data
Mar. 31, 2010 (KR) 10-2010-0029023

(51) Int. Cl. G06F 3/041

(52) U.S. Cl. 345/173

(57) ABSTRACT

An apparatus and method determine a user input pattern in a portable terminal even in a situation of a wide luminance range. Sensing information is acquired through a sensing unit that includes a plurality of sensors of different luminance sensing ranges. A luminance situation of a current environment is determined based on the sensing information. A touch input is detected based on the sensing information. And the user input pattern is determined based on sensing information of at least one luminance sensor that corresponds to the luminance situation of the current environment.

### CROSS-REFERENCE TO RELATED APPLICATION(S) AND CLAIM OF PRIORITY

This application claims priority under 35 U.S.C. §119(a) to an application filed in the Korean Intellectual Property Office on Mar. 31, 2010 and assigned Serial No. 10-2010-0029023, the entire disclosure of which is hereby incorporated by reference.

### TECHNICAL FIELD OF THE INVENTION

The present invention relates to an apparatus and method for determining a user touch input pattern in a portable terminal. More particularly, the present invention relates to an apparatus and method for improving a user input sensing rate during a situation in which a luminance range is widely distributed in the portable terminal.

### BACKGROUND OF THE INVENTION

In recent years, the use of portable terminals due to the convenience of their portability. Thus, service providers (i.e., terminal manufacturers) are competitively developing portable terminals that include more convenient functions to secure many users.

For example, the portable terminals provide functions of a phone book, a game, a scheduler, a Short Message Service (SMS), a Multimedia Message Service (MMS), a Broadcast Message Service (BMS), an Internet service, an Electronic mail (E)-mail, a morning call, a MPEG-1 Audio Layer 3 (MP3), a digital camera, and such.

Also, touch screen portable terminals capable of inputting data using a user's hand or a stylus pen have been developed, so users could easily, simply, and conveniently compose texts and draw lines in the portable terminal.

The touch screen portable terminals sense a pressure applied by a user and determine touch input occurrence at a corresponding position. The above method is an alternative means for existing button input, and has a problem of not being capable of sensing finger rotation after touch.

Accordingly, a technology for determining a user finger position and direction using a plurality of light receiving sensors installed around a touch screen has been discussed. The technology would have made the portable terminals determine a user touch input pattern and rearrange icons of a non-visible region in a visible region.

However, a problem with the discussed technology is that the portable terminal is sensitive to only one of a low luminance of a dark indoor environment and a high luminance of strong solar light in a situation in which a luminance range is widely distributed.

For example, when the portable terminal senses low luminance using a high luminance sensor, peripheral luminance information becomes less than a threshold value of the high luminance sensor and, when the portable terminal senses high luminance using a low luminance sensor, peripheral luminance information becomes more than a threshold value of the low luminance sensor. As such, it is not capable of acquiring an accurate sensing value.

Accordingly, in order to increase the sensitivity, the portable terminals have additionally installed correction circuits, but these have increased the cost of the portable terminals.

Thus, there is a need for an apparatus and method for acquiring accurate sensing information of low luminance and high luminance when a luminance range is widely distributed in the portable terminal.

### SUMMARY OF THE INVENTION

To address the above-discussed deficiencies of the prior art, it is a primary aspect of the present invention is to substantially solve at least the above problems and/or disadvantages and to provide at least the advantages below. Accordingly, one aspect of the present invention is to provide an apparatus and method for determining a user touch input pattern in a portable terminal.

Another aspect of the present invention is to provide an apparatus and method for acquiring accurate sensing information in a situation in which a luminance range is widely distributed in a portable terminal.

Another aspect of the present invention is to provide an apparatus and method for, through sensors of different detection ranges, enabling acquisition of accurate sensing information even in a situation of a wide luminance range in a portable terminal.

The above aspects are achieved by providing an apparatus and method for determining a user input pattern in a portable terminal.

According to an aspect of the present invention, an apparatus for determining a user input pattern in a portable terminal is provided. The apparatus includes a sensing unit, a pattern determiner, a memory unit, and a control unit. The sensing unit includes a plurality of sensors of different luminance sensing ranges and acquires sensing information. The pattern determiner determines a luminance situation of a current environment based on the sensing information, and determines the user input pattern based on sensing information of at least one luminance sensor that corresponds to the luminance situation of the current environment. The memory unit stores information for the luminance situation of the current environment. The controller detects a touch input based on the sensing information and controls the pattern determiner to determine the user input pattern when the touch input is detected.

According to another aspect of the present invention, a method for determining a user input pattern in a portable terminal is provided. The method includes acquiring sensing information through a sensing unit that includes a plurality of sensors of different luminance sensing ranges. A luminance situation of a current environment is determined based on the sensing information. A touch input is detected based on the sensing information. And a user input pattern is determined based on sensing information of at least one luminance sensor that corresponds to the luminance situation of the current environment.

According to yet another aspect of the present invention, an apparatus for determining a user input pattern in a portable terminal is provided. The apparatus includes a sensing unit, a memory unit, and a control unit. The sensing unit includes a plurality of sensors of different luminance sensing ranges and acquires sensing information. The memory unit stores information for a luminance situation of a current environment. The controller determines the luminance situation of the current environment, detects a touch input based on the sensing information, and determines the user input pattern based on sensing information of at least one luminance sensor that corresponds to the luminance situation of the current environment.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning, and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a construction of a portable terminal that enables acquisition of accurate sensing information even in a situation of a wide luminance range according to an embodiment of the present invention;

FIG. 2 illustrates a process of determining a user touch input pattern in a portable terminal according to an embodiment of the present invention;

FIG. 3A illustrates a portable terminal cross arranging sensors of different sensing ranges according to an embodiment of the present invention; and

FIG. 3B illustrates a portable terminal arranging pairs of sensors of different sensing ranges according to an embodiment of the present invention.

Throughout the drawings, like reference numerals will be understood to refer to like parts, components and structures.

### DETAILED DESCRIPTION OF THE INVENTION

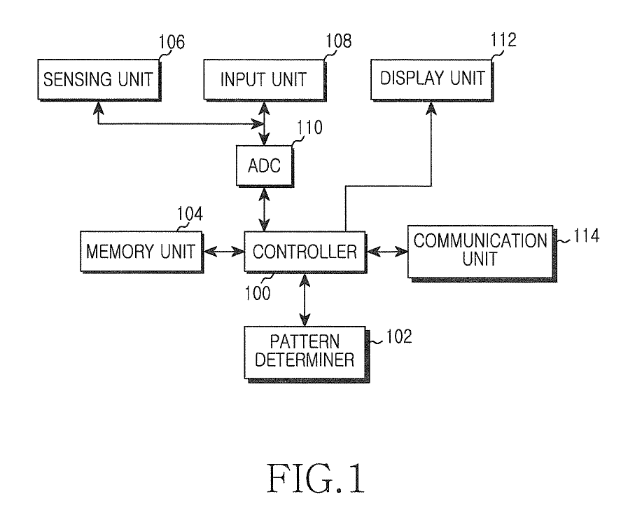

FIGS. 1 through 3B, discussed below, and the various embodiments used to describe the principles of the present disclosure in this patent document are by way of illustration only and should not be construed in any way to limit the scope of the disclosure.

The following description is made for an apparatus and method for determining a user touch input pattern even in a situation of a wide luminance range in a portable terminal according to the present invention. Also, the user touch input pattern may refer to a user input hand direction, a finger position, a finger rotation direction, a non-visible region, a visible region, and such.

FIG. 1 illustrates a portable terminal that enables acquisition of accurate sensing information even in a situation of a wide luminance range according to an embodiment of the present invention.

As shown in FIG. 1, the portable terminal may include a controller 100, a pattern determiner 102, a memory unit 104, a sensing unit 106, an input unit 108, an Analog to Digital Converter (ADC) 110, a display unit 112, and a communication unit 114.

The controller 100 of the portable terminal controls a general operation of the portable terminal. For example, the controller 100 performs a process and control for voice call and data communication. In addition to a general function, according to the present invention, after the controller 100 determines a user finger position, movement direction, and such, using a value measured by the sensing unit 106, and determines a user touch input pattern, the controller 100 performs an operation corresponding to the user touch input pattern.

The controller 100 also determines a change of sensing information according to user touch input by determining a luminance value of a peripheral environment.

For example, when the controller 100 senses luminance (i.e., a change of luminance) through a low luminance sensor, the controller 100 may determine that a current environment corresponds to a low luminance situation. In contrast, when the controller 100 senses luminance (i.e., a change of luminance) through a high luminance sensor, the controller 100 may determine that the current environment corresponds to a high luminance situation.

After determining the luminance of the peripheral environment, the controller 100 determines a user touch input pattern through a sensing value of a sensor corresponding to the luminance of the peripheral environment.

After the controller 100 controls the pattern determiner 102 to determine the luminance value of the peripheral environment, the controller 100 may determine the user touch input pattern.

Under the control of the controller 100, the pattern determiner 102 determines a user touch input pattern using a value measured by the sensing unit 108.

Additionally, under the control of the controller 100, the pattern determiner 102 determines sensing information acquired through the sensing unit 106 and determines a luminance value of a peripheral environment.

For example, the pattern determiner 102 determines a peripheral luminance value corresponding to a sensor exhibiting a sensitive response, among sensing information acquired through a low luminance sensor and a high luminance sensor, and determines a user touch input pattern based on the sensing information of the corresponding sensor that exhibited the sensitive response.

The memory unit 104 preferably includes, for example, a Read Only Memory (ROM), a Random Access Memory (RAM), a flash ROM, and such. The ROM stores a microcode of a program for processing and controlling the controller 100 and the pattern determiner 102 and a various types of reference data.

The RAM, a working memory of the controller 100, stores temporary data generated during the execution of a various programs. The flash ROM stores a updateable depository data such as a phone book, an outgoing message, an incoming message, and such. According to an embodiment of the present invention, the memory unit 104 stores information for current-environment luminance situation determination.

The sensing unit 106 may be composed of a plurality of light receiving sensors for sensing light, and may forward measurement values of the light receiving sensors to the ADC 110. The ADC 110 converts a measurement value provided from the sensing unit 106 into a digital value, forwards the digital value to the controller 100, and allows the controller 100 to determine a user touch input pattern. At this time, the sensing unit 106 may be constructed by sensors of different detection ranges, e.g., can be constructed by cross arranging low luminance sensors and high luminance sensors in order to acquire accurate sensing information in a situation where a luminance range is widely distributed.

The input unit 108 includes numeral key buttons ‘0’ to ‘9’, a menu button, a cancel button, an OK button, a talk button, an end button, an Internet button, navigation key buttons, and a plurality of function keys such as a character input key. The input unit 108 provides key input data corresponding to a key pressed by a user to the controller 100.

The display unit 112 displays state information generated during an operation of the portable terminal, numerals and characters, moving pictures, still pictures, and such. The display unit 112 may be a color Liquid Crystal Display (LCD), Active Mode Organic Light Emitting Diode (AMOLED), and such. When the display unit 112 includes a touch input device and is applied to a portable terminal of a touch input scheme, the display unit 112 may be used as an input device of the touch input portable terminal.

The communication unit 114 performs a function of transmitting and receiving and processing wireless signals through an antenna (not illustrated). For example, in a transmission mode, the communication unit 114 performs a function of processing source data through channel coding and spreading, converting the source data into a Radio Frequency (RF) signal, and transmitting the RF signal. In a reception mode, the communication unit 114 performs a function of converting a received RF signal into a baseband signal, processing the baseband signal through de-spreading and channel decoding, and restoring the signal to source data.

A role of the pattern determiner 102 may be implemented by the controller 100 of the portable terminal. In FIG. 1, these components are illustrated as being separately constructed for convenience in description. However, this does not limit the scope of the present invention. Those skilled in the art would recognize that various modifications of construction can be made within the scope of the present invention. For example, construction can also be such that two or more of the functions described above with respect to various components are processed in the controller 100.

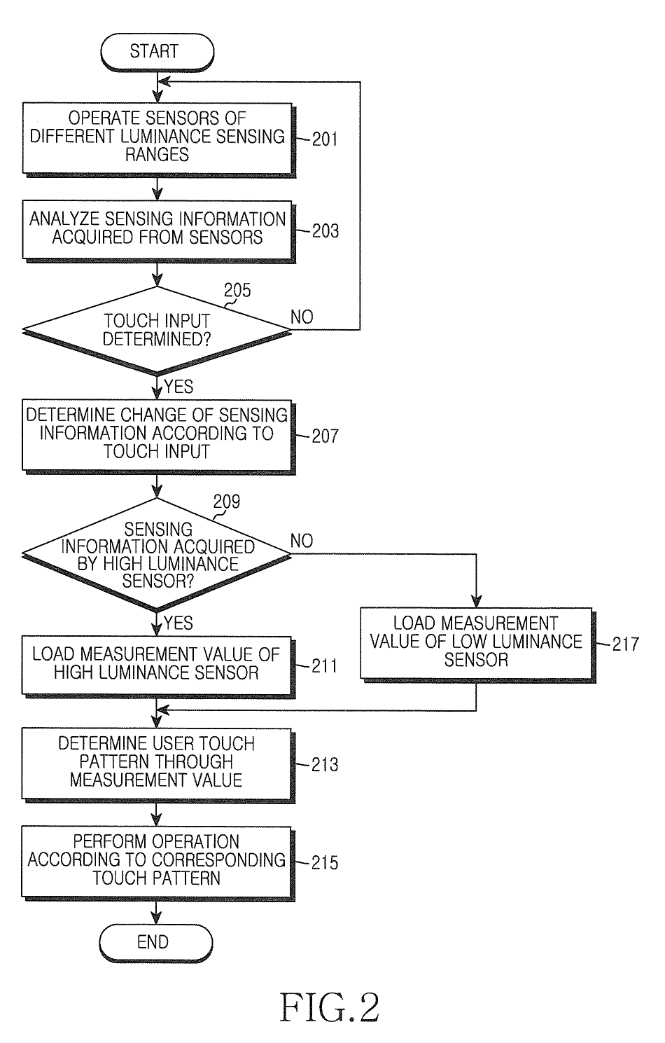

FIG. 2 illustrates a process of determining a user touch input pattern in a portable terminal according to an embodiment of the present invention.

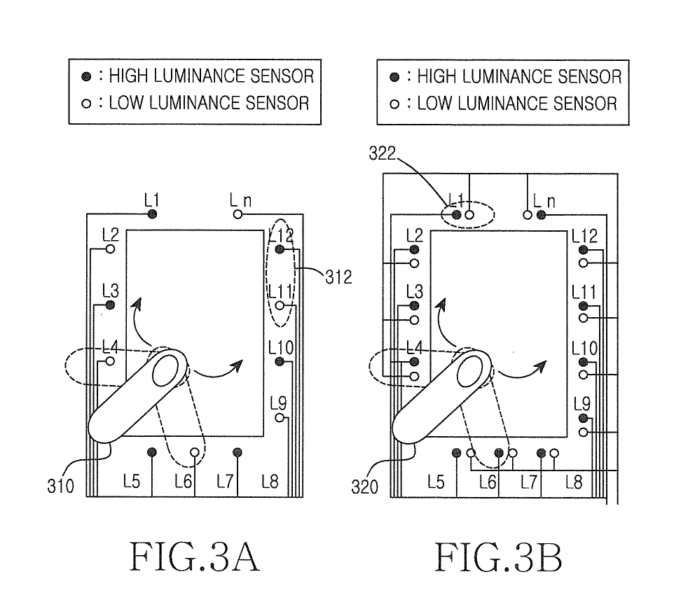

As shown in FIG. 2, the portable terminal includes a plurality of light receiving sensors (i.e., photo diodes or photo transistors) (L1 to Ln of FIG. 3) for sensing light around a display screen. The portable terminal may cross arrange and include high luminance sensors for sensing light of a high luminance environment and low luminance sensors for sensing light of a low luminance environment.

When a user's finger is put on the display screen, a portion of the display screen is shadowed by the finger, and measurement values of a light receiving sensor positioned in the shadowed portion and a light receiving sensor positioned in a non-shadowed portion become different from each other.

As described above, the portable terminal can determine a user touch input pattern through measurement values of light receiving sensors. The portable terminal can acquire an accurate measurement value even in a situation where a luminance range is widely distributed, by crossing high luminance sensors for sensing light of a high luminance environment and low luminance sensors for sensing light of a low luminance environment.

To acquire the accurate measurement value in the situation in which the luminance range is widely distributed as above, after the portable terminal operates sensors of different luminance sensing ranges in block 201, the portable terminal proceeds to block 203 and analyzes sensing information acquired from the sensors of the different luminance sensing ranges.

In block 205, the portable terminal determines user touch input.

At this time, the portable terminal can determine whether user touch input occurs by using measurement values acquired by the sensors. For example, when a user of the portable terminal positions a finger or a stylus pen on a sensor so as to perform touch input, the sensor of the corresponding position fails to sense light, so the portable terminal can determine that touch input has occurred. When all sensors sense light, the portable terminal can determine that the touch input has not occurred.

If the portable terminal determines that the touch input has not occurred in block 205, the portable terminal again performs the process of block 201.

In contrast, when the portable terminal determines that the touch input has occurred in block 205, the portable terminal proceeds to block 207 and determines a change of sensing information dependent on the touch input and determines a luminance value of a peripheral environment.

That is, the portable terminal analyzes sensing information acquired from the sensors of the different luminance sensing ranges in block 207, to determine whether the sensor sensing the touch input is a low luminance sensor or a high luminance sensor.

In block 207, the portable terminal determines the result of block 207.

If the sensing information is acquired by a high luminance sensor in block 209, the portable terminal proceeds to block 211 and loads a measurement value of the high luminance sensor. In block 213, the portable terminal determines a user touch input pattern using the loaded measurement value. Here, the portable terminal may determine whether a user of the portable terminal conducts a left-handed touch input pattern or a right-handed touch input pattern, using a position of a light receiving sensor that senses no light and a measurement value of a light receiving sensor that senses light, and the portable terminal can sense light of a high luminance environment using the high luminance sensor.

In contrast, when determining that the sensing information is acquired by a low luminance sensor in block 209, the portable terminal proceeds to block 217 and loads a measurement value of the low luminance sensor. In block 213, the portable terminal determines a user touch input pattern using the loaded measurement value. Here, the portable terminal can determine whether a user of the portable terminal conducts a left-handed touch input pattern or a right-handed touch input pattern, by using a position of a light receiving sensor that senses no light and a measurement value of a light receiving sensor that senses light, and the portable terminal can sense light of a low luminance environment using the low luminance sensor.

In block 215, the portable terminal performs an operation corresponding to the determined user touch input pattern.

After that, the portable terminal terminates the procedure according to an embodiment of the present invention.

In FIG. 2, an embodiment of the present invention describes a process of, after determining touch input or non-input using a change of sensing information acquired from sensors of different luminance sensing ranges, determining the type of the sensor (e.g. a light receiving sensor that senses no light or a light receiving sensor that senses light) that acquired the sensing information determining the touch input or non-input. Alternatively, before determining the touch input or non-input, the embodiment of the present invention may determine the type of the sensor that is acquiring the sensing information and determine a peripheral luminance.

FIGS. 3A and 3B illustrate a portable terminal according to an embodiment of the present invention.

FIG. 3A illustrates a portable terminal cross arranging sensors of different sensing ranges according to an embodiment of the present invention.

As shown in FIG. 3A, the portable terminal includes a plurality of light receiving sensors (L1 to Ln) for sensing light around a display screen. That is, the portable terminal cross arranges light receiving sensors 312 in the order of a high luminance sensor (L1) and a low luminance sensor (L2).

When a user's finger 310 is put on the display screen, a portion of the display screen is shadowed by the finger 310, and measurement values of a light receiving sensor positioned in the shadowed portion and a light receiving sensor positioned in a non-shadowed portion change. By using the measurement values, the portable terminal can determine a user touch input pattern.

When the portable terminal does not include repeating the order of the high luminance sensor (L1) and the low luminance sensor (L2) as shown above, i.e., when the portable terminal includes only homogeneous sensors, because the portable terminal is sensitive only to one of a low luminance of a dark indoor environment and a high luminance of strong solar light in a situation where a luminance range is widely distributed, there is a problem that the portable terminal should select only either the low luminance or the high luminance.

However, when the portable terminal alternates the high luminance sensor (L1) and the low luminance sensor (L2) according to an embodiment of the present invention, although the portable terminal is located in a place of a wide luminance range, the portable terminal can acquire accurate sensing information in a low luminance situation and a high luminance situation.

That is, assuming a situation that the portable terminal acquires sensing information through the low luminance sensor and the high luminance sensor in a low luminance situation, the portable terminal will be able to acquire sensing information corresponding to a user touch through the low luminance sensor.

However, in the low luminance situation, the portable terminal cannot sense a shadow corresponding to a user's touch through a high luminance sensor.

That is, in the low luminance situation, the portable terminal can sense a change of sensing information on user touch input through the low luminance sensor, so the portable terminal processes to convert, by the ADC 110, the sensing information acquired from the low luminance sensor into a digital value and forward the digital value to the controller 100.

FIG. 3B illustrates a portable terminal arranging pairs of sensors of different sensing ranges according to an embodiment of the present invention.

As shown in FIG. 3B, as illustrated, the portable terminal includes a plurality of light receiving sensors (L1 to Ln) for sensing light around a display screen. In an embodiment, the portable terminal may include light receiving sensors 322 that arrange a high luminance sensor and a low luminance sensor into a pair (L1), and acquire sensing information based on a motion of a user's finger 320.

When the portable terminal includes light receiving sensors that include a pair (L1) of a high luminance sensor and a low luminance sensor as above, the portable terminal senses luminance information on one peripheral environment with two sensors, and the portable terminal can determine a user touch input pattern using luminance information corresponding to a peripheral environment among the luminance information sensed with the two sensors.

As described above, the present invention, which relates to an apparatus and method for improving a user input sensing rate of a situation in which a luminance range is widely distributed, enables acquisition of accurate sensing information even in a situation of a wide luminance range through sensors of different detection ranges. As such, the present invention can provide a solution to a conventional problem of not being capable of acquiring accurate sensing information of low luminance and high luminance in a situation where a luminance range is widely distributed in a portable terminal.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for determining a user input pattern in a portable terminal, the apparatus comprising:
a sensing unit comprising a plurality of luminance sensors of different luminance sensing ranges and configured to acquire sensing information from each luminance sensor;
a pattern determiner configured to determine a luminance situation of a current environment based on the sensing information, and configured to determine the user input pattern based on sensing information of at least one luminance sensor that corresponds to the luminance situation of the current environment;
a memory unit configured to store information for the luminance situation of the current environment; and
a controller configured to detect a touch input based on the sensing information, and control the pattern determiner to determine the user input pattern when the touch input is detected.

2. The apparatus of claim 1, wherein the controller is further configured to control the pattern determiner to determine the luminance situation of the current environment after detecting the touch input.

3. The apparatus of claim 1, wherein the controller is further configured to control the pattern determiner to determine the luminance of the current environment before detecting the touch input.

4. The apparatus of claim 1, wherein, the pattern determiner is further configured to determine that the luminance situation corresponds to a low luminance situation when sensing a change of luminance based on a change of sensing information from a low luminance sensor, and determine that the luminance situation corresponds to a high luminance situation when sensing a change of luminance based on a change of sensing information from a high luminance sensor.

5. The apparatus of claim 1, wherein the plurality of luminance sensors comprises a plurality of low luminance sensors and a plurality of high luminance sensors.

6. The apparatus of claim 5, wherein the sensing unit is constructed by one of cross arranging the low luminance sensors and high luminance sensors and arranging pairs of luminance sensors, each pair comprising a low luminance sensor and a high luminance sensor.

7. The apparatus of claim 1, wherein the pattern determiner is further configured to determine at least one of a user input hand direction, a finger position, a finger rotation direction, a non-visible region, and a visible region using a measurement value of the sensing unit.

8. The apparatus of claim 1, wherein the pattern determiner is further configured to determine whether the user input pattern is left-handed based on a position of a luminance sensor that senses substantially no light and a measurement value of a luminance sensor that senses light.

9. A method for determining a user input pattern in a portable terminal, the method comprising:
acquiring sensing information through a sensing unit comprising a plurality of luminance sensors of different luminance sensing ranges;
determining a luminance situation of a current environment based on the sensing information;
detecting a touch input based on the sensing information; and
determining the user input pattern based on sensing information of at least one luminance sensor that corresponds to the luminance situation of the current environment.

10. The method of claim 9, the luminance situation of the current environment is determined after detecting the touch input.

11. The method of claim 9, wherein the luminance situation of the current environment is determined before detecting the touch input.

12. The method of claim 9, wherein determining the luminance situation of the current environment comprises:
detecting a change of the sensing information;
when sensing a change of luminance from a low luminance sensor through the change of the sensing information, determining that the luminance situation of the current environment corresponds to a low luminance situation; and
when sensing a change of luminance from a high luminance sensor through the change of the sensing information, determining that the luminance situation of the current environment corresponds to a high luminance situation.

13. The method of claim 9, wherein acquiring the sensing information comprises acquiring sensing information of a sensing unit comprises acquiring sensing information from a plurality of low luminance sensors and a plurality of high luminance sensors.

14. The method of claim 13, wherein the sensing unit comprised of the plurality of low luminance sensors and high luminance sensors is constructed by one of cross arranging the low luminance sensors and high luminance sensors and arranging pairs of luminance sensors, each pair comprising a low luminance sensor and a high luminance sensor.

15. The method of claim 9, wherein determining the user input pattern comprises determining at least one of a user input hand direction, a finger position, a finger rotation direction, a non-visible region, and a visible region using a measurement value of the sensing unit.

16. The method of claim 9, wherein determining the user input pattern comprises determining whether the user input pattern is left-handed based on a position of a luminance sensor that senses substantially no light and a measurement value of a luminance sensor that senses light.

17. An apparatus for determining a user input pattern in a portable terminal, the apparatus comprising:
a sensing unit comprised of a plurality of luminance sensors of different luminance sensing ranges and configured to acquire sensing information from each luminance sensor;
a memory unit configured to store information for a luminance situation of a current environment; and
a controller configured to determine the luminance situation of the current environment based on the sensing information, detect a touch input based on the sensing information, and determine the user input pattern based on sensing information of at least one luminance sensor that corresponds to the luminance situation of the current environment.

18. The apparatus of claim 17, wherein the controller is further configured to determine that the luminance situation corresponds to a low luminance situation when sensing a change of luminance based on a change of sensing information from a low luminance sensor, and determine that the luminance situation corresponds to a high luminance situation when sensing a change of luminance based on a change of sensing information from a high luminance sensor.

19. The apparatus of claim 17, wherein the plurality of luminance sensors comprises a plurality of low luminance sensors and a plurality of high luminance sensors, and
wherein the sensing unit is constructed by one of cross arranging the low luminance sensors and high luminance sensors and arranging pairs of luminance sensors, each pair comprising a low luminance sensor and a high luminance sensor.

20. The apparatus of claim 17, wherein the controller is further configured to determine whether the user input pattern is left-handed based on a position of a luminance sensor that senses substantially no light and a measurement value of a luminance sensor that senses light.
